(19) United States
(12) Patent Application Publication
(10) Pub. No.: US 2011/0037611 A1
(43) Pub. Date: Feb. 17, 2011

(54) PROGRAMMING A UNIVERSAL REMOTE CONTROL USING MULTIMEDIA DISPLAY

(75) Inventors: Paul Van Vleck, Austin, TX (US); Steven M. Belz, Cedar Park, TX (US); Gregory Edwards, Austin, TX (US); James Pratt, Round Rock, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/541,021

(22) Filed: Aug. 13, 2009

(51) Int. Cl. G08C 19/00

(52) U.S. Cl. 340/825.69; 340/825.72

(57) ABSTRACT

A method and system for programming a universal remote control (URC) to operate with a remote-controlled device is disclosed. A plurality of selectable objects representing different remote-controlled devices is displayed. A user may select an object and thereby determine an identity of the remote-controlled device. Programming codes for the identified remote-controlled device may be obtained and used to program the URC to control the remote-controlled device.

### BACKGROUND

1. Field of the Disclosure

The present disclosure relates to remote-controlled devices and, more particularly, to programming universal remote-controlled devices.

2. Description of the Related Art

Remote-controlled devices provide convenient operation of equipment from a distance. Many consumer electronic devices are equipped with remote control features. Universal remote-controlled devices, may be configured to control different pieces of equipment.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 a block diagram of selected elements of an embodiment of a universal remote control system;

FIG. 5 illustrates an embodiment of a method for programming a universal remote control; and

FIG. 6 illustrates an embodiment of a method for programming a universal remote control.

### DESCRIPTION OF THE EXEMPLARY EMBODIMENTS

In one aspect, a disclosed method for configuring a universal remote control (URC) over a multimedia content distribution network (MCDN) includes displaying a plurality of selectable objects representing a plurality of remote-controlled devices, and receiving user input selecting one of the displayed plurality of objects, such that an identity of a selected remote-controlled device represented by the selected object is determined. The method also includes programming the URC to control the selected remote-controlled device. The selectable objects may include images of different remote-controlled devices. The selectable objects may include objects representing different device types of remote-controlled devices. The selectable objects may include objects representing at least one of: device manufacturer, device model number, device version number, device name, and device product number.

In certain embodiments, the method may further include sending a request to a server for programming codes for the selected remote-controlled device, the request including an indication of the identity, and receiving the programming codes from the server, while programming the URC is performed using the programming codes. The server may be an MCDN server. Prior to programming, the method may further include displaying a confirmation of the identity of the selected remote-controlled device. The method may further include displaying a confirmation indicating that the URC was successfully configured with at least one programming code for the selected remote-controlled device. The URC may be programmed using a wireless communication link.

In a further aspect, disclosed customer premises equipment (CPE) for use within a client configuration of an MCDN includes a processor, a local transceiver, and memory media accessible to the processor, including instructions executable by the processor. The processor instructions may be executable to receive user input selecting at least one displayed object representing a remote-controlled device, such that an identity of the remote-controlled device is determined, and to program, using the local transceiver, a URC to control the remote-controlled device. The CPE may further include processor instructions executable to display selectable objects representing a plurality of remote-controlled devices. The local transceiver may be a wireless transceiver. In response to a request to an MCDN server for programming codes for the remote-controlled device, the CPE may further include processor instructions executable to receive programming codes from the MCDN server, and use the programming codes to program the URC. The request may include an indication of the identity. The CPE may still further include processor instructions executable to output an indication that the URC was successfully programmed to control the remote-controlled device.

In yet another aspect, a disclosed computer-readable memory media includes executable instructions for configuring a URC for use within a client configuration of an MCDN. The instructions may be executable to enable a user to select an identity of a remote-controlled device based on a menu of device information objects displayed to the user. Based on the selected identity, the instructions may further be executable to program the URC to control the remote-controlled device.

In particular embodiments, the memory media includes instructions executable to send a request to a server for programming codes, the request including the selected identity, receive programming codes from the server, and use the programming codes to program the URC. The device information objects may include images of different remote-controlled devices. The device information objects may include objects indicative of at least one of: device manufacturer, device class, device model number, device version number, device name, and device product number. The URC may be programmed via a wireless interface. The menu may include a plurality of pages displaying device information objects. The plurality of pages may include a separate page for each of at least one of the following device information objects: device type objects, manufacturer objects, model objects, version objects, name objects, and product number objects.

In the following description, details are set forth by way of example to facilitate discussion of the disclosed subject matter. It should be apparent to a person of ordinary skill in the field, however, that the disclosed embodiments are exemplary and not exhaustive of all possible embodiments.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

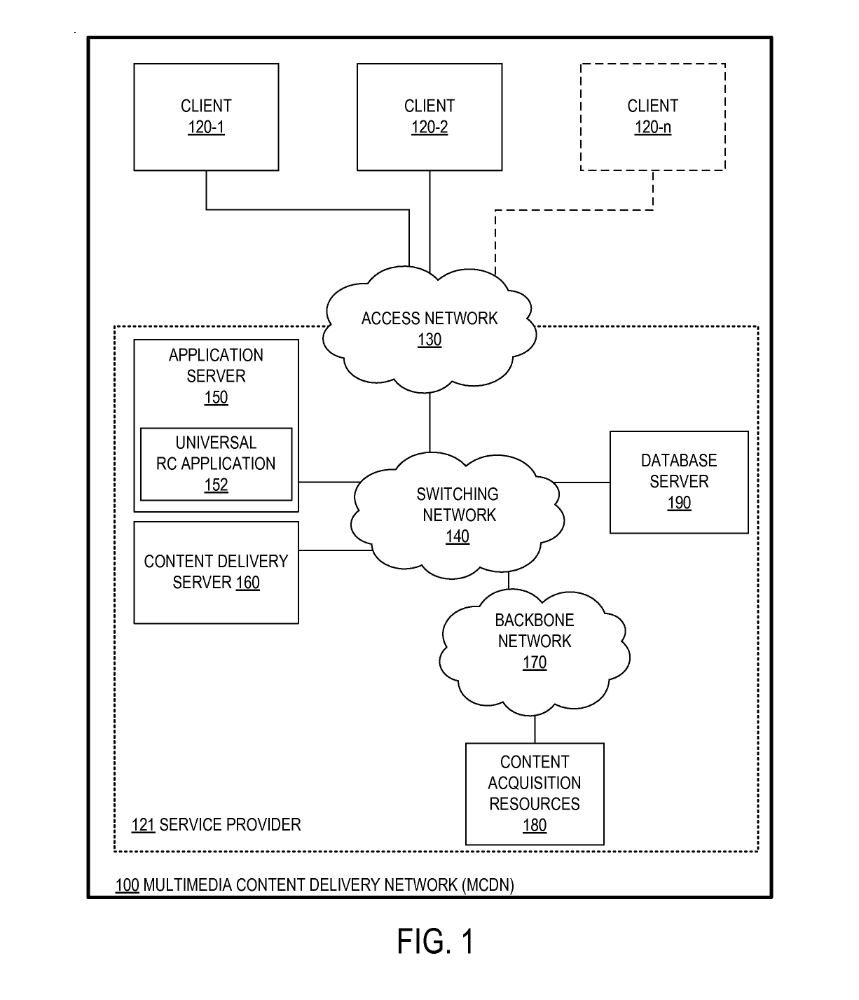

Turning now to the drawings, FIG. 1 is a block diagram illustrating selected elements of an embodiment of MCDN 100. Although multimedia content is not limited to TV, video on demand (VOD), or pay-per-view (PPV) programs, the depicted embodiments of MCDN 100 and its capabilities are primarily described herein with reference to these types of multimedia content, which are interchangeably referred to herein as “multimedia content”, “multimedia content programs”, “multimedia programs” or, simply, “programs.”

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twisted pair cables, fiber optic cables, or a combination thereof MCDN 100 may include digital subscriber line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

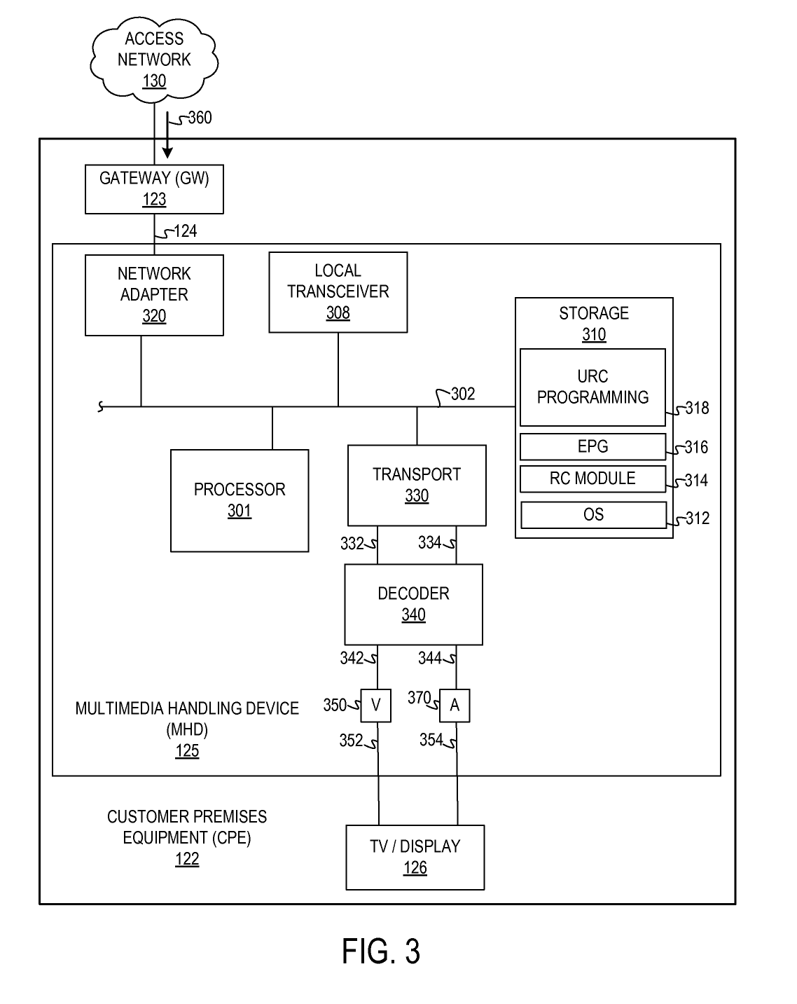

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG), such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPGs, digital video recording (DVR) services, VOD programs, PPV programs, IPTV portals, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include URC application 152, which, as will be described in detail below, mat be configured to cause client 120 of MCDN 100 to reprogram a URC device.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120. Database server 190 may also store device information, such as identifiers for client 120, model identifiers for remote-controlled devices, and programming codes for URCs.

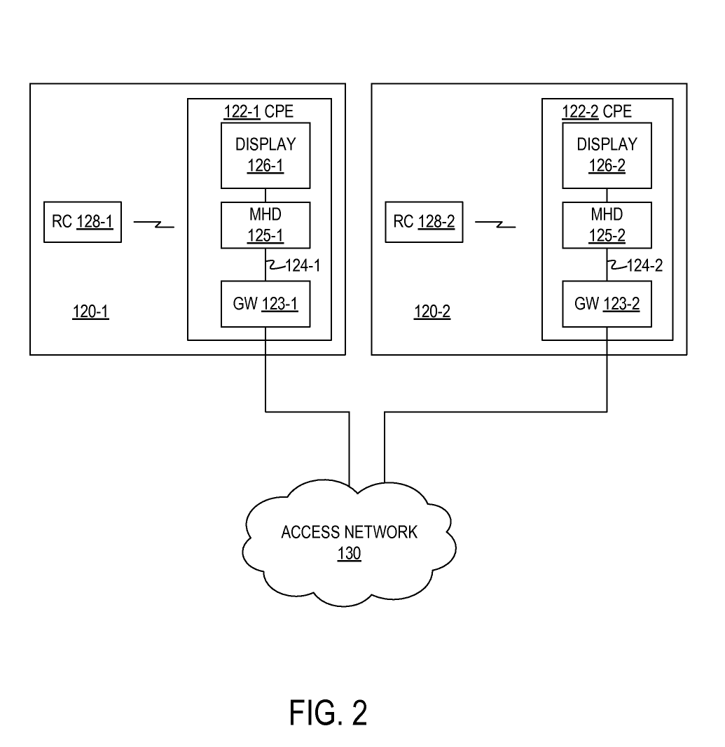

Turning now to FIG. 2, clients 120 are shown in additional detail with respect to access network 130. Clients 120 may include a network appliances collectively referred to herein as CPE 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125.

In some embodiments, remote control 128 may represent a URC device that is configured to control multiple pieces of equipment. When the equipment controlled by the URC device changes, the URC device may be reprogrammed, for example, to add a new device. The URC device may be programmed using a local transceiver (see FIG. 3) coupled to CPE 122. In some cases, CPE 122 may receive network commands to reprogram the URC device, as will be described in detail below.

MHD 125 is enabled and configured to process incoming multimedia signals to produce audio and visual signals suitable for delivery to display 126 and any optional external speakers (not depicted in FIG. 2). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based MCDN.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP-based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHD 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 370 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown may include sets or sequences of instructions, namely, an operating system 312, a remote control application program identified as RC module 314, an EPG 316, and URC programming 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In some embodiments, URC application 152 (see FIG. 1), in conjunction URC programming 318, provides functionality to reprogram or reconfigure a URC device, as will now be described in further detail below.

Local transceiver 308 represents an interface of MHD 125 for communicating with external devices, such as remote control 128, or another URC device. Local transceiver 308 may provide a mechanical interface for coupling to an external device, such as a plug, socket, or other proximal adapter. In some cases, local transceiver 308 is a wireless transceiver, configured to send and receive IR or RF or other signals. A URC device configured to operate with CPE 122 may be reconfigured or reprogrammed using local transceiver 308. In some embodiments, local transceiver 308 is also used to receive commands for controlling equipment from the URC device. Local transceiver 308 may be accessed by RC module 314 for providing remote control functionality.

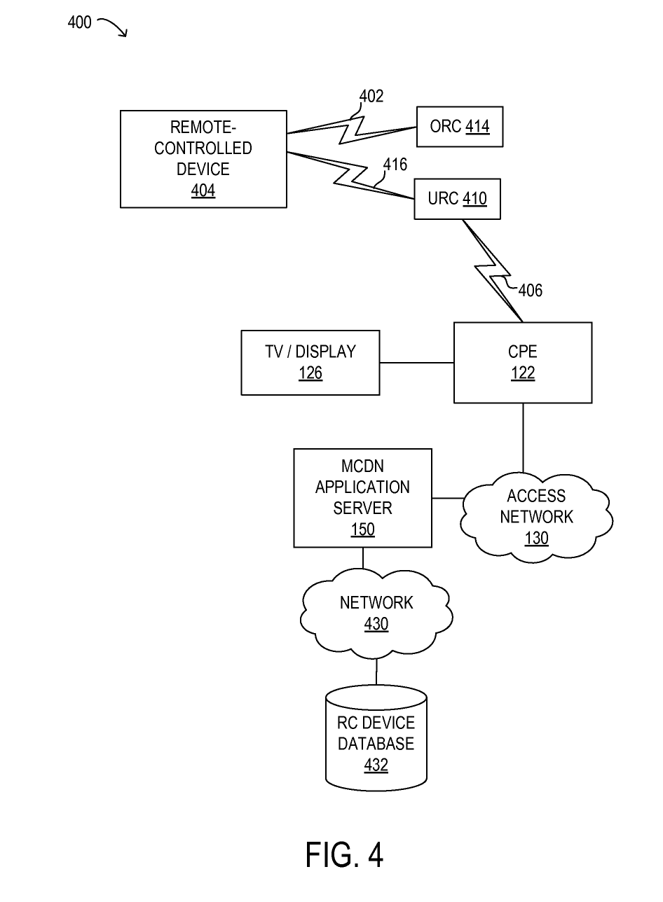

Turning now to FIG. 4, a block diagram of selected elements of an embodiment of URC system 400 is depicted. In URC system 400, original remote control (ORC) 414, URC 410, and CPE 122 may be in proximity to remote-controlled device 404, for example at a location of an MCDN client 120. URC system 400 illustrates devices, interfaces and information that may be processed to program URC 410 to control remote-controlled device 404. The reconfiguring, or reprogramming, of URC 410 may be complex, error prone, or time-consuming for a user. URC system 400 is a platform that may allow a user to reprogram URC 410 using services provided by MCDN 100. It is noted that in FIG. 4, communication links 402, 406, and 416 may be wireless or mechanically connected interfaces. It is further noted that like numbered elements in FIG. 4 represent components discussed above with respect to FIGS. 1-3.

In FIG. 4, remote-controlled device 404 refers to a piece of equipment that is introduced for use with or near CPE 122. In some embodiments, remote-controlled device 404 may be controllable by remote control, and may be suitable for control by URC 410. Remote-controlled device 404 may also represent an existing instrument or device that is in use, but not yet controllable using URC 410, because URC 410 may not yet be configured to control remote-controlled device 404. Remote-controlled device 404 may further include one or more local transceivers or interfaces (not explicitly shown in FIG. 4) for communicating with remote controls, or for control by another piece of equipment.

ORC 414 may be a remote control that is dedicated for operation with remote-controlled device 404, for example, via communication link 402. That is, ORC 414 may represent original equipment provided with remote-controlled device 404, such that remote-controlled device 404 and ORC 414 may communicate via communication link 402 as a stand-alone unit. ORC 414 may be configured to use codes, or coded instructions, that are specific to remote-controlled device 404. ORC 414 may further be specific to a device-type (i.e., model, configuration, etc.) corresponding to remote-controlled device 404, such that ORC 414 may be operable with any manufactured instance of a particular device model, represented by remote-controlled device 404.

In some cases remote-controlled device 404 may be coupled to CPE 122. The coupling to CPE 122 may be subordinate in nature, such that remote-controlled device 404 may be controlled by CPE 122 in response to commands or signals received by local transceiver 308 (see FIG. 3). In other cases, remote-controlled device 404 may communicate directly with CPE 122 via a direct communication link (not depicted).

In FIG. 4, URC 410 may communicate with CPE 122 via communication link 406. Communication link 406 may be used to receive remote-control commands (i.e., in the form of codes or instructions) from URC 410. Alternatively, communication link 406 may be used to reprogram (i.e., reconfigure) URC 410 to send different commands or to control different equipment. For example, communication link 406 may be used to reconfigure URC 410 to use programming codes corresponding to remote-controlled device 404. In some instances, communication link 406 may be used to limit or delete existing functionality, for which URC 410 may be configured.

In FIG. 4, after URC 410 has been configured with at least some programming codes corresponding to remote-controlled device 404, URC 410 may communicate via communication link 416 with remote-controlled device 404. That is, URC 410 may emulate at least some functionality using communication link 416 that ORC 414 is capable of using communication link 402. From the perspective of remote-controlled device 404, communication links 402 and 416 may appear identical or indistinguishable. In other words, remote-controlled device 404 may not be aware that URC 410 is emulating ORC 414, and may respond to communication links 402 or 416 in an identical manner.

It is noted that in FIG. 4, a pathway for URC 410 controlling remote-controlled device 404 is depicted in URC system 400. The pathway is communication link 416, which represents direct control of remote-controlled device 404 by URC 410, without intervention from CPE 122. URC 410 may further directly communicate with CPE 122 via communication link 406, for example, using local interface 308 (see FIG. 3). URC 410 may receive programming codes via communication link 406 from CPE 122, and may further send acknowledgements or other messages to CPE 122.

In FIG. 4, CPE 122 may communicate with MCDN application server 150 via access network 130. Access network 130 may represent a “last-mile” access network providing service to a large number of MCDN client systems (see FIGS. 1-3). MCDN application server 150 may, in turn, communicate with external systems using network 430, for example, with RC device database 432. As illustrated in FIG. 4, MCDN application server 150 may retrieve RC device information from RC device database 432 over network 430. Network 430 may be a public or private network, while RC device database 432 may be operated by an external business entity. RC device database 432 may include device information for a variety of different RC devices, which may be controllable by URC 410. The RC device information may include programming codes for specific RC devices. Thus, MCDN application server may 150 may query RC device database 432, in one embodiment, using a model identifier to retrieve programming codes for remote-controlled device 404. It is noted that in different embodiments (not shown in FIG. 4) RC device database 432 may be included as an internal component of MCDN application server 150, and may be accessed directly using network 430 or another network

In operation of URC system 400, as shown in FIG. 4, a user (not shown) may initiate a URC configuration request to CPE 122 for configuring URC 410. On TV/display 126, CPE 122 may display a plurality of objects representing a plurality of remote-controlled devices. The user may provide user input to CPE 122, thereby selecting one of the displayed plurality of objects. The selection as a result of the user input may determine an identity of remote-controlled device 404. CPE 122 may further display, or otherwise send, at least one potential identity for remote-controlled device 404 to the user. The user may then acknowledge and/or confirm the identity. CPE 122 may obtain programming codes based on the identity of remote-controlled device 404. The programming codes may be obtained by CPE 122 from a local database (not shown in FIG. 4).

In various embodiments, CPE 122 may now use the identity to query MCDN application server 150 for programming codes for remote-controlled device 404. In some instances, MCDN application server 150 may, in turn, obtain the programming codes from RC device database 432, which may be provided by a third party. After obtaining or retrieving the desired programming codes, MCDN application server 150, executing URC application 152 (see FIG. 1), may send the programming codes back to CPE 122. CPE 122 may prompt the user to place URC 410 in a location accessible by communication link 406. CPE 122 may then program URC 410 with at least some of the programming codes. CPE 122 may display an indication of being ready to reprogram URC 410 and/or an indication that communication link 406 to URC 410 has been established. In some cases, CPE 122 may wait for user input before proceeding to configure URC 410. Finally, CPE 122 may send or display an acknowledgement to the user that URC 410 has been successfully configured for use with remote-controlled device 404 using communication link 416.

After URC 410 has been programmed, or reprogrammed, CPE 122 may receive a confirmation via communication link 406, and may display an indication that URC 410 has been successfully configured to control remote-controlled device 404. In some cases, CPE 122 may transmit the confirmation / indication of successful URC configuration to MCDN application server 150, which may, in turn, send a confirmation to another device, such as a user mobile communications device, originating the URC configuration request.

After being successfully configured, URC 410 may control remote-controlled device 404. In one embodiment, URC 410 may use communication link 416 to directly control remote-controlled device 404.

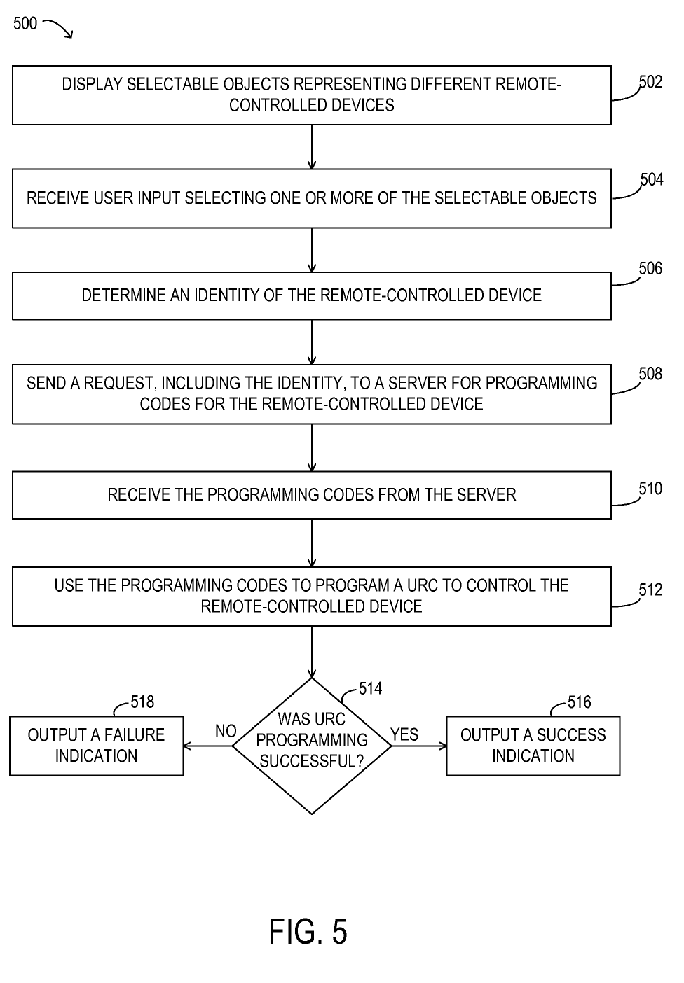

Turning now to FIG. 5, an embodiment of method 500 for programming a URC is illustrated. In one embodiment, method 500 is performed by URC programming 318 executing on MHD 125 of CPE 122. Method 500 may also be performed in conjunction with functionality provided by URC application 152 executing on application server 150. It is noted that certain operations described in method 500 may be optional or may be rearranged in different embodiments. In method 500, it is assumed that remote-controlled device 404 has been introduced alongside CPE 122 of MCDN client 120, and that URC 410 is capable of controlling remote-controlled device 404 (see FIG. 4).

In method 500, selectable objects representing different remote-controlled devices may be displayed (operation 502). A plurality of selectable objects may be displayed on TV/display 126 by CPE 122 (see FIGS. 3 and 4). The selectable objects may be displayed in a menu, such as a menu provided by EPG 316 (see FIG. 3). The menu may include a plurality of pages, or screens, displaying the selectable objects. In certain embodiments, each page in the menu may be dedicated to different types of selectable objects, such as, but not limited to: device type objects, manufacturer objects, model objects, version objects, name objects, and product number objects. In this manner, a user may be provided with the option to choose the object type, and then an individual object.

Next, user input selecting one or more of the selectable objects may be received (operation 504). The user input may involve selecting an object in the menu. An identity of the remote-controlled device may be determined (operation 506). The selectable object may represent a particular remote-controlled device. The identity may further be presented to the user for confirmation, including displaying additional objects of different types for the identified remote-controlled device. A request, including the identity, for programming codes for the remote-controlled device may be sent to a server (operation 508). Next, the programming codes may be received from the server (operation 510). Programming codes, usable to program the URC, may be obtained in response to sending a request or query to an MCDN server. The request may include the identity of the remote-controlled device. The identity may be given by a model number, a device number, a part number, a serial number, a model name or description, other device information, or a combination thereof. The programming codes may be received from the server via an access network. The programming codes may then be used to program a URC to control the remote-controlled device (operation 512). At least some of the programming codes received from the server may be used to program the URC. In some embodiments, the URC is programmed with codes corresponding to respective programming codes for the remote-controlled device, such that the URC can generate commands associated with the programming codes.

In method 500, a decision may then be made whether or not the URC programming was successful (operation 514). The decision may be made in response to receiving an acknowledgement of programming, such as a confirmation or an error message, from the URC. If the result of operation 514 is YES, then a success indication may be output (operation 516). If the result of operation 514 is NO, then a failure indication may be output (operation 518). The indication for output in either operation 516 or 518 may be a displayed indication, an audio indication, or a message transmitted to a user.

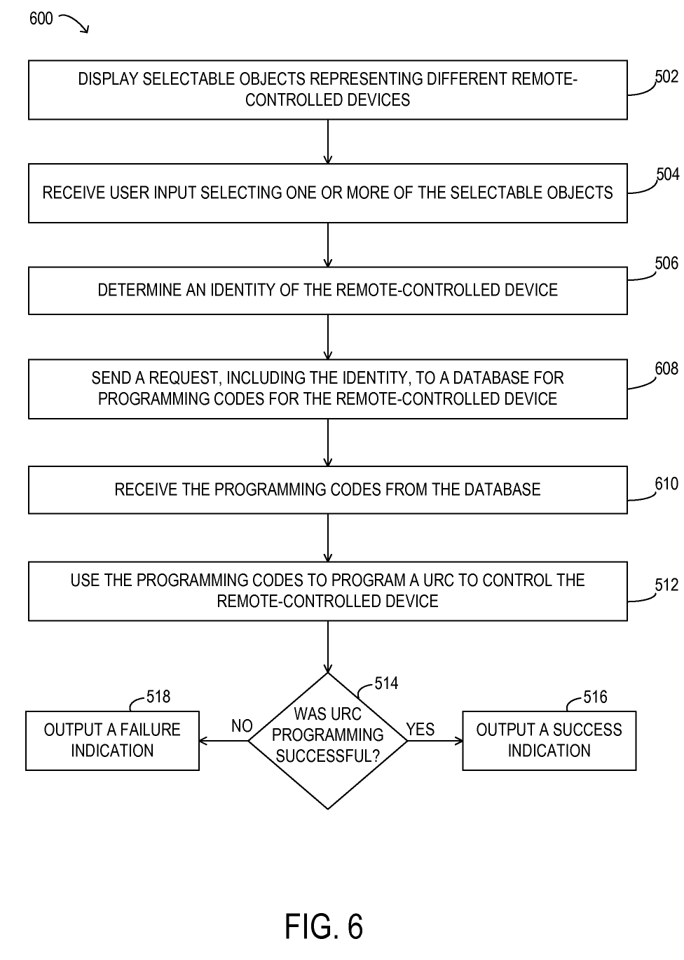

Turning now to FIG. 6, an embodiment of method 600 for programming a URC is illustrated. Method 600 is similar to method 500, in which like numbered elements are described above. In method 600, a request, including the identity, for programming codes for the remote-controlled device may be sent to a database (operation 608). The programming codes may then be received from the database (operation 610). In certain embodiments, the database may be located on CPE 122. The database may be supplied or operated by a third-party, and may include device information objects for a variety of remote-controlled devices. In some embodiments, the database is accessed by sending a query to an MCDN server over an access network, which then relays the query to the database over another network connection, and returns the result (i.e., the programming codes for the remote-controlled device) back to the requestor.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for configuring a universal remote control (URC) over a multimedia content distribution network (MCDN), comprising:
displaying a plurality of selectable objects representing a plurality of remote-controlled devices;
receiving user input selecting one of the displayed plurality of objects, wherein an identity of a selected remote-controlled device represented by the selected object is determined; and
programming the URC to control the selected remote-controlled device.

2. The method of claim 1, wherein the selectable objects include images of different remote-controlled devices.

3. The method of claim 1, wherein the selectable objects include objects representing different device types of remote-controlled devices.

4. The method of claim 1, wherein the selectable objects include objects representing at least one of: device manufacturer, device model number, device version number, device name, and device product number.

5. The method of claim 1, further comprising:
sending a request to a server for programming codes for the selected remote-controlled device, the request including an indication of the identity; and
receiving the programming codes from the server,
wherein said programming the URC is performed using the programming codes.

6. The method of claim 5, wherein the server is an MCDN server.

7. The method of claim 1, further comprising:
prior to said programming, displaying a confirmation of the identity of the selected remote-controlled device.

8. The method of claim 1, further comprising:
displaying a confirmation indicating that the URC was successfully configured with at least one programming code for the selected remote-controlled device.

9. The method of claim 1, wherein the URC is programmed using a wireless communication link.

10. A customer premises equipment (CPE) for use within a client configuration of a multimedia content distribution network (MCDN), comprising:
a processor;
a local transceiver; and
memory media accessible to the processor, including instructions executable by the processor to:
receive user input selecting at least one displayed object representing a remote-controlled device, wherein an identity of the remote-controlled device is determined; and
program, using the local transceiver, a universal remote control (URC) to control the remote-controlled device.

11. The CPE of claim 10, further comprising processor instructions executable to:
display selectable objects representing a plurality of remote-controlled devices.

12. The CPE of claim 11, wherein the selectable objects include images of different remote-controlled devices.

13. The CPE of claim 11, wherein the selectable objects include objects representing different device types of remote-controlled devices.

14. The CPE of claim 11, wherein the selectable objects include objects representing at least one of: device manufacturer, device model number, device version number, device name, and device product number.

15. The CPE of claim 10, wherein the local transceiver is a wireless transceiver.

16. The CPE of claim 10, further comprising processor instructions executable to:
in response to a request to an MCDN server for programming codes for the remote-controlled device, the request including an indication of the identity, receive programming codes from the MCDN server; and
use the programming codes to program the URC.

17. The CPE of claim 10, further comprising processor instructions executable to:
output an indication that the URC was successfully programmed to control the remote-controlled device.

18. Computer-readable memory media, including instructions for configuring a universal remote control (URC) for use within a client configuration of a multimedia content distribution network, said instructions executable to:
enable a user to select an identity of a remote-controlled device based on a menu of device information objects displayed to the user; and
based on the selected identity, program the URC to control the remote-controlled device.

19. The memory media of claim 18, further comprising instructions executable to:
send a request to a server for programming codes, the request including the selected identity;
receive programming codes from the server; and
use the programming codes to program the URC.

20. The memory media of claim 18, wherein the device information objects include images of different remote-controlled devices.

21. The memory medium of claim 18, wherein the device information objects include objects indicative of at least one of: device manufacturer, device class, device model number, device version number, device name, and device product number.

22. The memory medium of claim 18, wherein the URC is programmed via a wireless interface.

23. The memory medium of claim 18, wherein the menu includes a plurality of pages displaying device information objects.

24. The memory medium of claim 23, wherein the plurality of pages includes a separate page for each of at least one of the following device information objects: device type objects, manufacturer objects, model objects, version objects, name objects, and product number objects.
